(19) United States
(12) Patent Application Publication
(10) Pub. No.: US 2003/0217148 A1
(43) Pub. Date: Nov. 20, 2003

(54) Method and apparatus for LAN authentication on switch

(76) Inventors: Glen H. Mullen, Baytown, TX (US); Matthew T. Novi, Houston, TX (US); Yan A. Noblot, Houston, TX (US)

Correspondence Address: ROSENTHAL & OSHA L.L.P., 1221 MCKINNEY AVENUE, SUITE 2800, HOUSTON, TX, 77010, US

(21) Appl. No.: 10/146,983

(22) Filed: May 16, 2002

(51) Int. Cl. G06F 15/16

(52) U.S. Cl. 709/225; 709/229; 713/201

(57) ABSTRACT

A network system includes a corporate network resource, a default network isolated from the corporate network resource, a client computer initially connected to the default network, and a switch comprising software to dynamically connect the client computer to the corporate network resource if an authentication response obtained from the client computer is valid.

### BACKGROUND OF INVENTION

Security devices, such as smart cards, are often used for identification of an entity. A smart card is a credit card-sized, tamper-resistant security device that offers functions for secure information storage and information processing that relies on Very-Large-Scale Integration (VLSI) chip technology. VLSI is generally considered to encompass the range from 5,000 to 50,000 components densely packed in an integrated circuit. A smart card contains a secure microprocessor chip embedded in the card. The chip can implement a secure file system, compute cryptographic functions, and actively detect invalid access attempts. With proper application of file system access rights, a smart card can be safely used by multiple, independent applications, such as identity authentication using Public Key Infrastructure (PKI) technology. Often, two-factor identity authentication is employed in conjunction with smart cards, the two factors being a Personal Identification Number stored on the smart card and PKI technology associated with stored data on the smart card. Typically, two-factor identity authentication using PKI technology proceeds when a user of the smart card successfully enters the PIN associated with the smart card.

The basic principle of PKI technology is a mathematical concept that can be used to relate certain pairs of large numbers (called keys) in a special way. If one of the keys is used to encrypt a message, the other key can be used to decrypt the message, and vice versa. Fundamental to this scheme is that only these two keys (called a key pair) are related in this way. So, in other words, if a message is encrypted with one key, the message can be decrypted only by the matching key in the pair. One key is called a private key and the other is called a public key. The private key is known only by the user; the public key is published as widely as the user desires.

The following is an example of how a private message is sent from a sender to a recipient using standard PKI technology and techniques. The recipient's public key is used to encrypt the message, which is then sent to the recipient as a response. The recipient uses his/her private key to decrypt the response. The sender knows that only the recipient can read the message because the response can only be decrypted using the recipient's private key. One concern with this arrangement is that the sender does not know whether the recipient's true public key is being used to encrypt the response. To overcome this concern, a digital certificate is employed.

A digital certificate binds a public key to an identity (and possibly other information about that identity). The sender and recipient share a trusted third party (e.g. a mutual friend, an organizational administrator, or a government agency). If the recipient goes to that trusted third party and proves his/her identity and presents his/her public key, that third party bundles and “signs,” or verifies the authenticity of the public key along with the recipient's identity and any other appropriate information. This bundle of information is called a digital certificate, and the process of obtaining one is called certificate issuance.

A notable property of digital certificates is that public key tampering can be readily detected. The digital certificate is signed by the trusted third party (called a certificate authority, or CA). If the digital certificate is tampered with, the sender can tell because the CA is not recognized or the certification is improperly signed. Further, the sender can look at the digital certificate and verify that the digital certificate was, in fact, signed by the intended trusted third party. This mechanism assures that the recipient's public key really belongs to the recipient, at least to the level that trust exists in the CA.

A security device such as a smart card typically carries a digital certificate, which is used in identity authentication. For example, in an authentication process where a smart card is used to authenticate identity for a transaction, a customer may walk into a store and attempt to make a purchase. In order to authenticate the customer's identity, the merchant may request the customer to insert the smart card into a security device reader. The security device reader prompts the customer to enter a PIN. The PIN is stored on the smart card when the digital certificate and a private key are stored on the smart card. The combination of the customer's possession of the smart card and the customer's knowledge of the PIN is part of a two-factor authentication process. A sequence of events using a smart card for PKI challenge authentication may proceed as follows: an authentication request is initiated by a customer, a challenge is generated, the challenge is signed by a private key on the smart card, and a response is sent to a local computer. Then, the local computer downloads a digital certificate containing a public key from a PKI server and uses the public key to authenticate the identity of the customer by verifying authentication information in the signed challenge. The local computer verified the authentication information in the signed challenge by verifying that the private key that signed the challenge matches the public key obtained from the PKI server. Then, a verification response (either affirmative or negative) is sent to the security device reader, and the security device reader typically provides some prompt to the waiting merchant as to whether the customer's identity has been authenticated.

Dual public and private keys may be used for PKI transactions, such as those involved in PKI challenge and response transactions, in order to enhance non-repudiation, wherein an entity signing a document with a particular private key cannot deny signing the document. Furthermore, since PKI technology may optionally employ time-stamping techniques, non-repudiation may be tied to the signing of a particular document by a particular entity at a particular time. Dual public and private keys are implemented by having a public encryption key and a public signature key, and a private encryption key and a private signature key. The private encryption key may be copied and stored for backup purposes, but the private signature key is typically maintained only in a single place (e.g., a smart card), thus enhancing non-repudiation. In a typical scenario using dual public and private keys, in sending a document from entity A to entity B, A will sign the document with A's private signing key and encrypt the signed document using B's public encryption key, then send the signed, encrypted document to B. B will use A's public signing key to verify that A sent the document, and decrypt the document using B's private encryption key.

Digital certificates used in PKI technology may be managed by a security management system. For instance, Entrust/Entelligence™ developed by Entrust Technologies of Plano, Tex., manages certificates, time stamping, encryption, digital signatures, and other security issues on behalf of users. Security management systems, such as Entrust/Entelligence™, also have features such as automatic key and certificate management, and centrally managed policies and settings. Entrust/Entelligence™ integrates into a client computer environment. Also, instead of a separate log in procedure for each application stored on the computer, a user logs in only once to securely access all applications that are secured with a product such as Entrust/Entelligence™.

Digital certificates used to verify a signed document may be stored on a server running a directory service. A directory service is a service running on a network that enables users to locate hosts and services, e.g., a certificate management service. An example of a directory service is Lightweight Directory Access Protocol (LDAP).

LDAP is the Internet standard for directory lookups, just as the Simple Mail Transfer Protocol (SMTP) is the Internet standard for delivering e-mail, and the Hypertext Transfer Protocol (HTTP) is the Internet standard for delivering documents. Technically, LDAP is defined as an “on the wire” bit protocol (similar to HTTP) that runs over Transmission Control Protocol/Internet Protocol (TCP/IP). LDAP creates a standard way for applications to request and manage directory information.

An LDAP-compliant directory leverages a single, master directory that owns all user, group, and access control information. The directory is hierarchical, not relational, and is optimized for reading, reliability, and scalability. This directory becomes a specialized, central repository that contains information about objects and provides user, group, and access control information to all applications on the network. For example, the directory can be used to provide a security management system with a user list, a user's public key information, or user identification for all users in a widely distributed enterprise.

Computer networks may be configured using switches. For example, Local Area Network (LAN) switches and Ethernet switches are often used to configure computer networks. One type of computer network connected using switches is known as a Virtual Local Area Network (VLAN). The VLAN typically uses one or more switches and network management software to logically segment corporate network resources (e.g., workstations, printers, servers, etc) into different subnets. This arrangement ensures that broadcast frames are switched only between switch ports within the same VLAN. VLANs are typically controlled by an Open Systems Interconnection (OSI) layer 2 (data link layer) switch such as shown FIG. 1.

A switch (10) groups network computer resources into two VLANs, VLAN 1 (12) and VLAN 2 (14). VLAN 1 (12) is made up of a first client (16) and a first server (18), each connected to a first hub (20). The first hub (20) is connected to port 1 (22) of the switch (10). VLAN 2 (12) is made up of a second client (24), a third client (26), a printer (28), each connected to a second hub (30). The second hub (30) is connected to port 2 (32) of the switch (10). A fourth client (34) and a second server (36) are both connected to a third hub (38). The third hub (38) is connected to port 3 (40) of the switch (10). VLANs created using a switch may be organized by port (e.g., a range of ports may be assigned to a certain VLAN), by Media Access Control (MAC) addresses, or by protocol, etc. The dotted line (42) represents that port 1 (22) is assigned to VLAN 1 (12), and port 2 (32) and port 3 (40) are assigned to VLAN 2 (14). A packet can be sent from one VLAN to another through a router (layer 3 device and higher) (44). The router (44) is connected to the switch (10) via port 4 (46). The switch's (10) internal, shared medium, referred to in the art as the switching fabric, is high-speed circuitry that forwards packets from a source to a destination. More than one VLAN may be connected to a single port, and more than one switch may be part of a particular VLAN.

A switch controlling a VLAN may be configured using network management software, such as CiscoView™ (trademark of Cisco Systems, Inc.).

Network management software often runs on a server connected to the switch, and is typically configured via a graphical or command line interface by a systems administrator in order to comply with corporate network resource needs. For example, referring to FIG. 1, a user on the first client (16), which is in VLAN 1 (12), may require access to data stored on the second server (36), which is in VLAN 2 (14). In order to allow the user access to the second server (36), a system administrator using network management software, reconfigures the switch (10) using a Graphical User Interface (GUI) to place the first workstation (16) into VLAN 2 (14).

Simple Network Management Protocol (SNMP) communications may be used to exchange information between devices on a network. For example, a software application known as an SNMP agent may run on a switch, such as the switch (10) in FIG. 1, and send data, such as statistics to a software application known as an SNMP manager. The SNMP manager may run on a server, such as the first server (18) in FIG. 1. In addition to sending statistics relating to usage matters (e.g., who is logged on at what computer and when, etc.) to the SNMP manager when requested, the SNMP agent may asynchronously send an SNMP notification (such as an SNMP trap) to the SNMP manager. For example, if the SNMP agent is running on the switch (10) in FIG. 1, and the SNMP manager is running on the first server (18), the SNMP agent may be configured to send an SNMP trap to the SNMP manager when certain events occur. For example, a user may turn on power to the second client (24), which precipitates an SNMP trap sent from the SNMP agent on the switch (10) to the SNMP manager on the first server (18). The SNMP manager typically saves records of statistics and SNMP traps in a log server.

Information security is becoming a paramount concern for many interests. Many measures may be taken to secure corporate computer resources. For examples, firewalls may be used to block an attack from outside a network. FIG. 2 illustrates a typical implementation of an enterprise system that uses a firewall. An enterprise system typically includes an enterprise server (60) connected to various computer resources, such as a database (62). The enterprise server (60) is also connected to an internal corporate network (64), including desktop computers, networked printers, etc., such as are shown in FIG. 1. The enterprise server (60) provides access to the Internet (66) for all resources operatively connected to it. Enterprise systems typically employ a firewall (68) as a security measure. The firewall (68) in the enterprise system protects the enterprise system from individuals outside the internal corporate network (64) from obtaining sensitive information, e.g., confidential files. The firewall (68) and similar security measures are often sufficient for securing the corporate resources such as the database (62) from intrusion from outside the network.

However, attackers may employ other techniques to bypass the firewall (68) and access corporate resources, such as the internal corporate network (64). For example, a hacker may gain access to a building housing the database (62), even though the building may be secured by key card entrances. For example, an attacker may wait until an employee opens the door with a key card, and grab the door before the door closes, walk into the building, sit down at a workstation, and access the database (62). Passwords needed for workstation logon are often obtained through similar “social engineering” attacks. Thus, the firewall (68) is bypassed. Attacks upon a corporate network may also come from employees of a corporation, even though such employees may be authorized to access the internal corporate network (64). For example, an employee may download sensitive material from the database (62) and copy the sensitive material for later unauthorized use or sale.

### SUMMARY OF INVENTION

In general, in one aspect, the invention relates to a network system. The network system comprises a corporate network resource, a default network isolated from the corporate network resource, a client computer initially connected to the default network, and a switch comprising software to dynamically connect the client computer to the corporate network resource if an authentication response obtained from the client computer is valid.

In general, in one aspect, the invention relates to a network system. The network system comprises a corporate network resource, a default network isolated from the corporate network resource, a client computer initially connected to the default network, a switch comprising software to connect the client computer to the corporate network resource if an authentication response obtained from the client computer is valid, and a security device, read by a security device reader, operatively connected to the client computer.

In general, in one aspect, the invention relates to a method for connecting a client computer to a corporate network resource. The method comprises obtaining a connection to a default network, triggering a request for an authentication response from the default network, generating the authentication response using a security device reader, sending the authentication response in response to the request, sending a reconfiguration signal to a switch if the response is correct, and re-configuring the switch using the re-configuration signal to connect the client computer to the corporate network resource.

In general, in one aspect, the invention relates to a method for connecting a client computer to a corporate network resource. The method comprises obtaining a connection to a default network, triggering a request for an authentication response from the default network, generating the authentication response using a security device reader, sending the authentication response in response to the request, verifying user identity using the authentication response and an authentication server, sending a reconfiguration signal to a switch if the authentication response is valid, and re-configuring the switch using the reconfiguration signal to connect the client computer to the corporate network resource.

In general, in one aspect, the invention relates to a method for maintaining a connection to a corporate network resource. The method comprises sending a challenge to a client computer connected to the corporate network resource, returning a response to the challenge, verifying whether the response to the challenge is correct, re-configuring a switch to terminate the connection to the corporate network resource, if the response to the challenge is not correct, and maintaining the connection to the connection to the corporate network resource, if the response to the challenge is correct, wherein a security device reader is used to generate an authentication response to initially connect the client computer to the corporate network resource.

In general, in one aspect, the invention relates to a computer system for connecting a client computer to a corporate network resource. The computer system comprises a processor, a memory, a storage device, and software instructions stored in the memory for enabling the computer system to perform obtaining a connection to a default network, triggering a request for an authentication response from the default network, generating the authentication response using a security device reader, sending the authentication response in response to the request, sending a reconfiguration signal to a switch if the response is correct, and re-configuring the switch using the re-configuration signal to connect the client computer to the corporate network resource.

In general, in one aspect, the invention relates to a computer system for maintaining a connection to a corporate network resource. The computer system comprises a processor, a memory, a storage device, and software instructions stored in the memory for enabling the computer system to perform sending a challenge to a client computer connected to the corporate network resource, returning a response to the challenge, verifying whether the response to the challenge is correct, re-configuring a switch to terminate the connection to the corporate network resource, if the response to the challenge is not correct, and maintaining the connection to the connection to the corporate network resource, if the response to the challenge is correct, wherein a security device reader is used to generate an authentication response to initially connect the client computer to the corporate network resource.

In general, in one aspect, the invention relates to an apparatus for connecting a client computer to a corporate network resource. The apparatus comprises means for obtaining a connection to a default network, means for triggering a request for an authentication response from the default network, means for generating the authentication response using a security device reader, means for sending the authentication response in response to the request, means for sending a reconfiguration signal to a switch if the response is correct, and means for re-configuring the switch using the re-configuration signal to connect the client computer to the corporate network resource.

An apparatus for maintaining a connection to a corporate network resource. The apparatus comprises means for sending a challenge to a client computer connected to the corporate network resource, means for returning a response to the challenge, means for verifying whether the response to the challenge is correct, means for re-configuring a switch to terminate the connection to the corporate network resource, if the response to the challenge is not correct, and means for maintaining the connection to the connection to the corporate network resource, if the response to the challenge is correct, wherein a security device reader is used to generate an authentication response to initially connect the client computer to the corporate network resource.

Other aspects and advantages of the invention will be apparent from the following description and the appended claims.

### BRIEF DESCRIPTION OF DRAWINGS

FIG. 1 illustrates a typical network divided into two Virtual Local Area Networks (VLANs) using a switch.

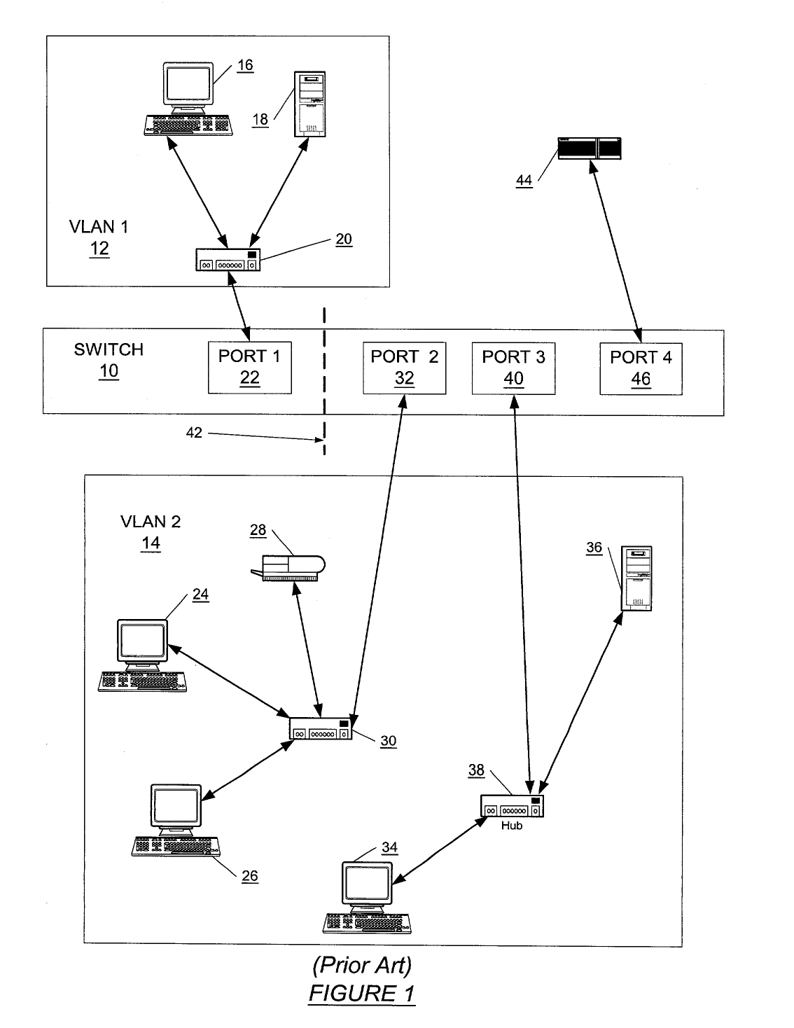

FIG. 2 illustrates a typical implementation of an enterprise system that uses a firewall.

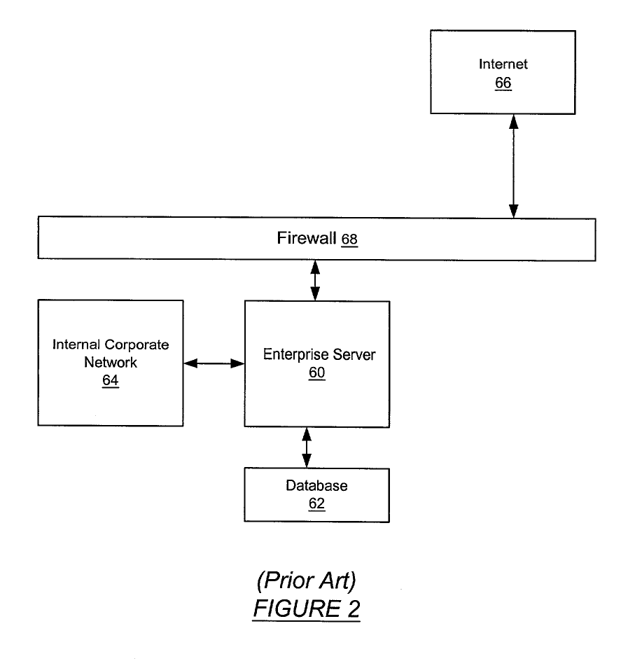

FIG. 3 shows a typical computer system.

FIG. 4 shows a network system, in accordance with one or more embodiments of the invention.

FIG. 5 shows, in accordance with one or more embodiments of the invention, a sequence of operations to handle attempted access of corporate network resources.

FIG. 6 shows, in accordance with one or more embodiments of the invention, a reconfigured network system resulting from granting a client computer access to corporate network resources.

FIG. 7 shows, in accordance with one or more embodiments of the invention, a sequence of operations to accomplish user-friendly mode maintenance access.

FIG. 8 shows, in accordance with one or more embodiments of the invention, a sequence of operations to accomplish secure mode maintenance access.

### DETAILED DESCRIPTION

Specific embodiments of the invention will now be described in detail with reference to the accompanying figures. Like elements in the various figures are denoted by like reference numerals for consistency.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

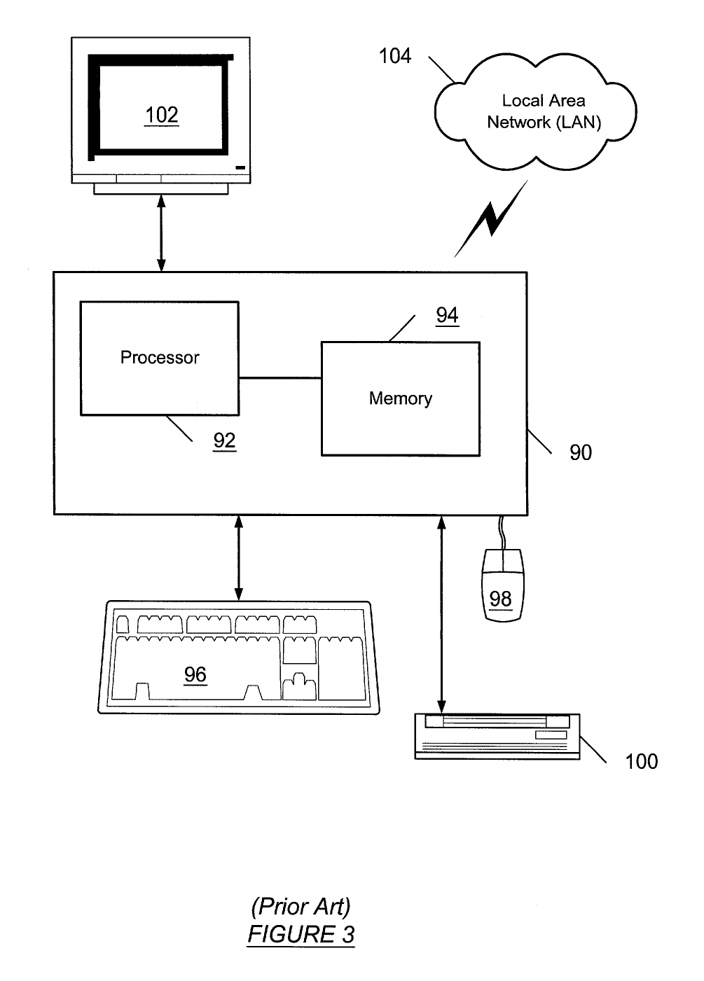

The invention described herein may involve any computer regardless of the platform being used. For example, as shown in FIG. 3, a typical computer (90) has a processor (92), memory (94), and numerous other elements and functionalities typical to today's computers (not shown). The computer (90) has associated therewith input means such as a keyboard (96), a mouse (98), and a card reader (100), although in an accessible environment these input means may take other forms. The computer (90) is also associated with an output device such as a display (102), which may also take a different form in an accessible environment. Finally, the computer (90) is connected to a LAN (104).

In one or more embodiments, the invention enables dynamic reconfiguration of a computer network using a switch (e.g., a LAN switch), where the dynamic reconfiguration of the computer network is dependent upon identity authentication of a user of a client computer. Through dynamic reconfiguration of the computer network using software resident on, or accessing, the switch, a connection to corporate network resources is granted or denied, maintained or terminated.

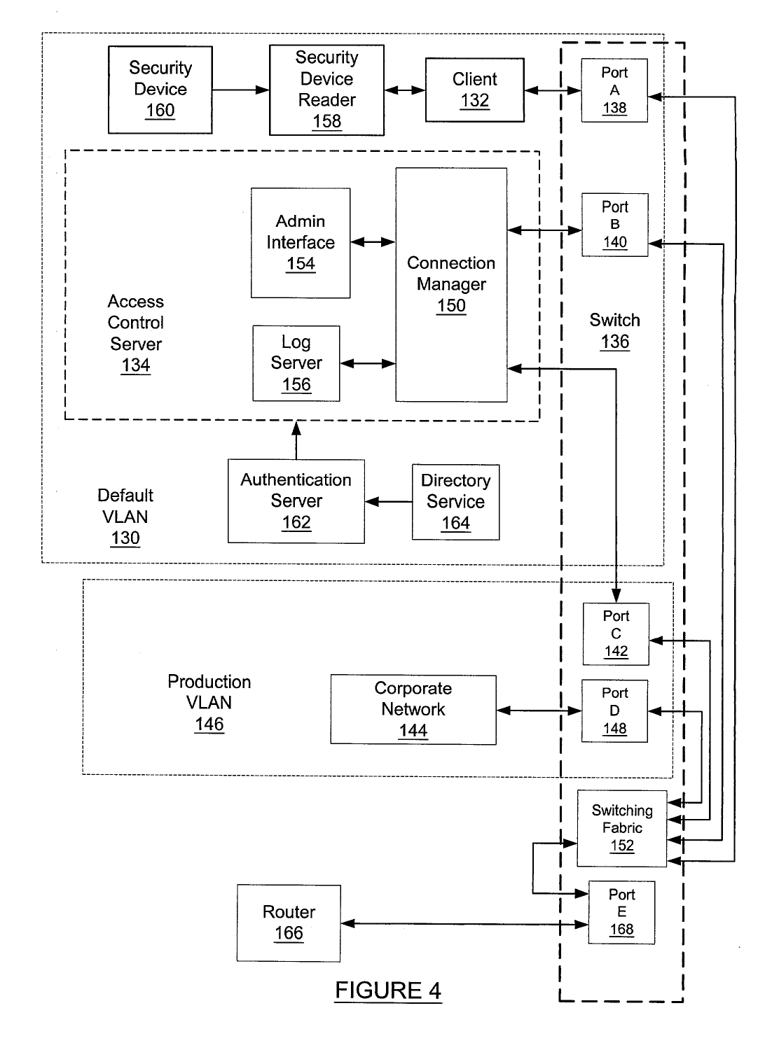

An example of a network system on which an embodiment of the invention runs is shown in FIG. 4. FIG. 4 shows a default VLAN network configuration (130), in which a client computer (132) is connected to an access control server (134) by a switch (136). The access control server (134) is software that enables dynamic, i.e., without the aid of a person such as a system administrator, reconfiguration of the switch (136). FIG. 4 shows the access control server (134) separate from the switch (136), although, in one or more embodiments of the invention, the access control server (134) may reside on the switch (136). Multiple switches may be employed, in accordance with one or more embodiments of the present invention. The switch (136) includes monitoring protocol functionality, e.g., SNMP agent functionality. The client computer (132) is connected to the default VLAN (130) through port A (138). The access control server (134) is connected to the default VLAN (130) through port B (140) and port C (142). A corporate network (144), such as a database, workstations, printers, etc., is connected to a production VLAN (146) through port D (148).

The access control server (134) includes a connection manager (150) that controls reconfiguration of the switch by manipulating switching fabric (152) of the switch (136). The connection manager (150) includes network management system functionality and SNMP manager functionality. An administrative interface (154) included in the access control server (134) enables viewing of current and historical network configurations, i.e., which users were using which client computers, during what time windows. Furthermore, through the use of the switch (136), the connection manager (150) and the administrative interface (154), a user of the client computer, such as an employee accessing or using the corporate network (144) inappropriately, may be placed into the default VLAN (130) manually or programmatically.

A log server (156) maintains a history of network configurations and allocations of resources of the corporate network (144), such as information related to a session (authentication information of a user, IP address of the switch, a MAC address of the client computer, a port number of the switch to which the client computer is connected, etc.). The log server (156) may be used, in one or more embodiments of the present invention, to create an audit trail for accountability purposes. For example, the administrative interface (154) may access the log server (156) and present session information (e.g., when a person, as identified by identity credentials obtained from a security device (160), was accessing the corporate network (144)).

The presentation of the session information may be implemented by using a graphical or command line interface, etc., for a system administrator. Thus, the system administrator may use the session information for auditing purposes, or for control purposes, such as terminating access to the client computer (132) based on the session information.

The access control server (134) is connected to an authentication server (162) and a directory service (164), such as an LDAP-compliant or Active Directory™ (trademarked by Microsoft Corporation) directory service, for PKI authentication purpose. The access control server (134) includes cryptographic functions as necessary to enable PKI authentication. In one or more embodiments of the present invention, the authentication server (162) and the directory service (164) may be incorporated into the access control server (134). A router (166) is connected to the switch (136) via port E (168). Switches A (138), B (140), C (142), D (148), and E (168) are connected to the switching fabric (152).

The client computer (132) includes cryptographic functions and is connected to a security device reader (158) that reads the security device (160), such as a smart card. The client computer (132) also includes functionality to coordinate with other entities, such as the access control server (134), and a user of the client computer (132). For example, the client computer (132) includes functionality to prompt the user appropriately, so as to enable the connection manager (150) to reconfigure the switch (136) as necessary. Communications between the access control server (134) and the switch (136) are enabled through monitoring protocol functionality, e.g., SNMP manager and SNMP agent functionality. However, instead of SNMP functionality, switch vendor command line interface (CLI) functionality may be used.

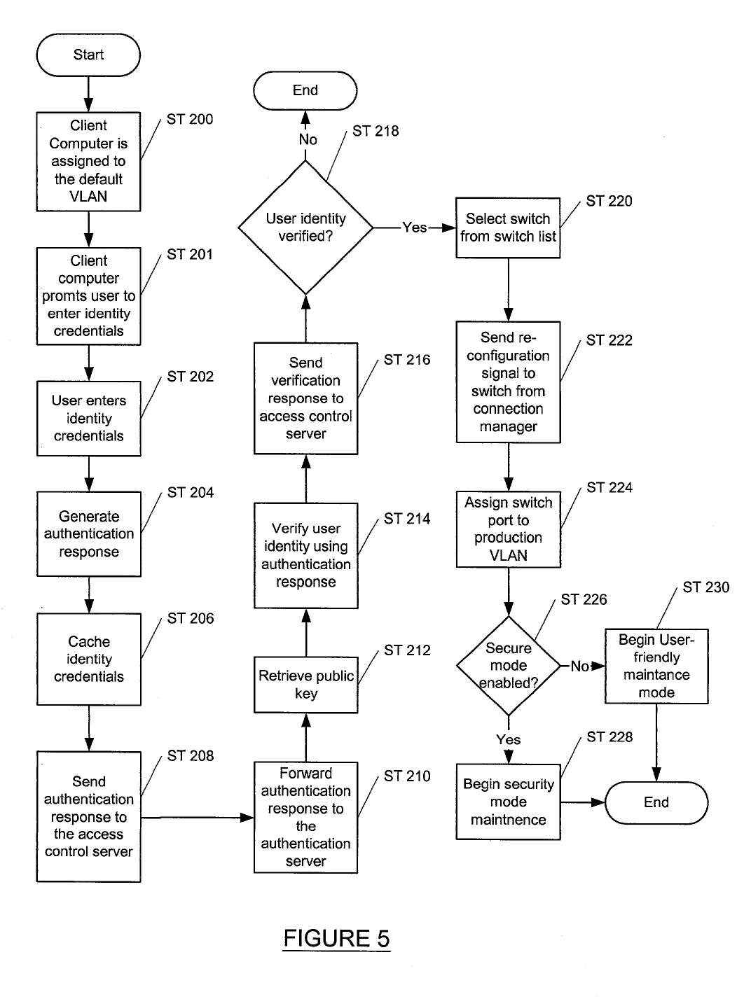

Users may attempt to gain access to the corporate network (144) through the client computer (132). A user may be a legitimate user, with the security device (160) (e.g., a smart card) to insert into the security device reader (158), or the user may be an illegitimate user, e.g., an attacker, such as a trespasser, attempting to gain access to the corporate network (144) by following an authorized employee through an open door into a building housing a secured database. Or an attack may come from an employee attempting to access the corporate network (144) inappropriately. For any of the above-mentioned scenarios, the present invention, in one or more embodiments, deals with attempted access of the corporate network (144) via the client computer (134) through a sequence of operations as shown in FIG. 5.

A first operation is assigning the client computer to the default VLAN (Step 200), which may occur well before attempted access by a user. Next, the user is prompted to enter identity credentials (Step 201). A user prompt may take form as a GUI prompt that is displayed continuously, or a prompt that is displayed upon attempted access, e.g., when the client computer is turned on. System events, such as when a user turns on the client computer, are detected by the SNMP agent functionality of the switch, and an SNMP trap is sent to the access control server SNMP manager functionality.

The user then enters identity credentials (Step 202). Identity credentials, in accordance with one or more embodiments of the present invention, are stored on, and read from, a security device, such as a smart card. The smart card includes, among other items, a digital certificate suitable for PKI authentication transactions, such as PKI challenge transactions. In accordance with one or more embodiments of the present invention, dual keys (private encryption and signature keys) are stored on the smart card, for non-repudiation purposes. The smart card is inserted into the security device reader, and the user is prompted for a PIN associated with the smart card. If the PIN entered by the user is the same as the PIN stored on the card, then the identity credentials are read from the smart card using the security device reader.

Once the identity credentials have been read from the smart card, an authentication response is generated using the smart card (Step 204). In accordance with one or more embodiments of the present invention, the authentication response is generated using standard PKI techniques.

The identity credentials are cached in a data store accessible to the client computer (Step 206). The authentication response is sent to the access control server (Step 208).

Also sent to the access control server is session information, such as a MAC address of the client computer, an Internet Protocol (IP) address of the port of the switch to which the client computer is connected, and possibly other information particular to the session on the client computer. Session information is stored in the log server for various purposes, such as creating an audit trail for non-repudiation purposes and for switch reconfiguration purposes.

When the access control server receives the authentication information, the authentication response is forwarded to an authentication server (e.g., a PKI server), (Step 210) and a public key is retrieved (Step 212), e.g., from a directory server. Using the authentication response and standard PKI authentication techniques, user identity is verified (Step 214). Standard PKI challenge techniques are used to verify user identity. For example, a one-way hash may be created using a public key and compared to a one-way hash derived from the authentication response.

A verification response is sent from the authentication server to the access control server (Step 216). In accordance with one or more embodiments of the present invention, user identity may be verified entirely on the access control sever, without the use of an authentication server. Thus, Steps 210-216 as shown above may be altered or eliminated as appropriate.

A determination is made as to whether user identity is verified (Step 218). If the user identity is not verified, no action is taken. Otherwise, if user identity is verified, a switch corresponding the switch to which the client computer is connected is selected from a switch list (Step 220). Once the switch has selected, a reconfiguration signal is sent from the connection manager of the access control server to the switch (Step 222). The re-configuration signal manipulates the switching fabric in order to assign the switch port onto which the client computer is connected into the production VLAN (Step 224).

Once switch port assignment is made, a determination is made as to whether secure mode maintenance access is enabled (Step 226). Enabling secure mode maintenance access may be accomplished through a number of means, e.g., a configuration file may be read upon granting access to corporate network resources in order to determine whether secure mode is enabled. Secure mode maintenance access is a maintenance phase of access wherein periodic challenges are sent to the client computer. If secure mode maintenance access is enabled, secure mode maintenance begins (Step 228). Otherwise, user-friendly mode maintenance access begins (Step 230). Periodic challenges are also sent to the client computer in user-friendly mode maintenance access.

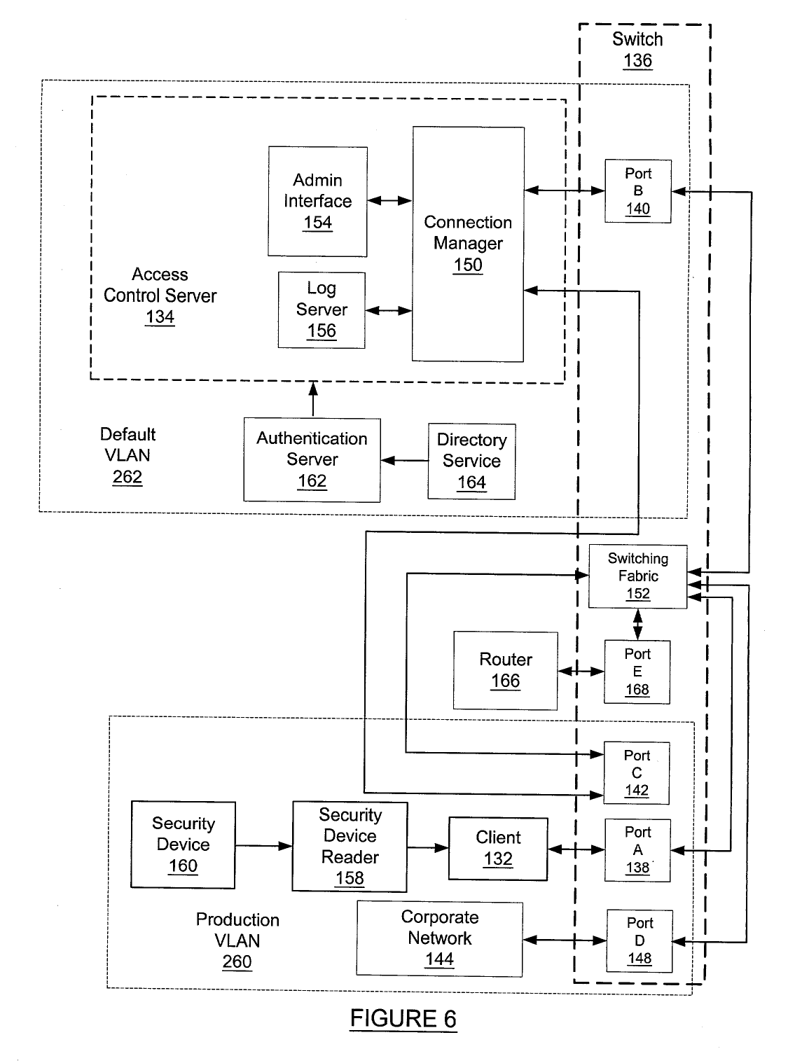

FIG. 6 shows the network system illustrated in FIG. 4 after reconfiguration resulting from granting the client computer access to the corporate network. After reconfiguration, the network system is unchanged from FIG. 4, except that port A (138), to which the client computer (132) is connected, is part of the production VLAN (260), along with the corporate network (144). After reconfiguration, the default VLAN (262) does not include the client computer (132). Other entities shown in FIG. 6 remain substantially unchanged from FIG. 4.

Access to the corporate network is granted as shown in FIG. 5 above. Termination of access to the corporate network may be accomplished in either user-friendly mode maintenance access, or in secure mode maintenance access.

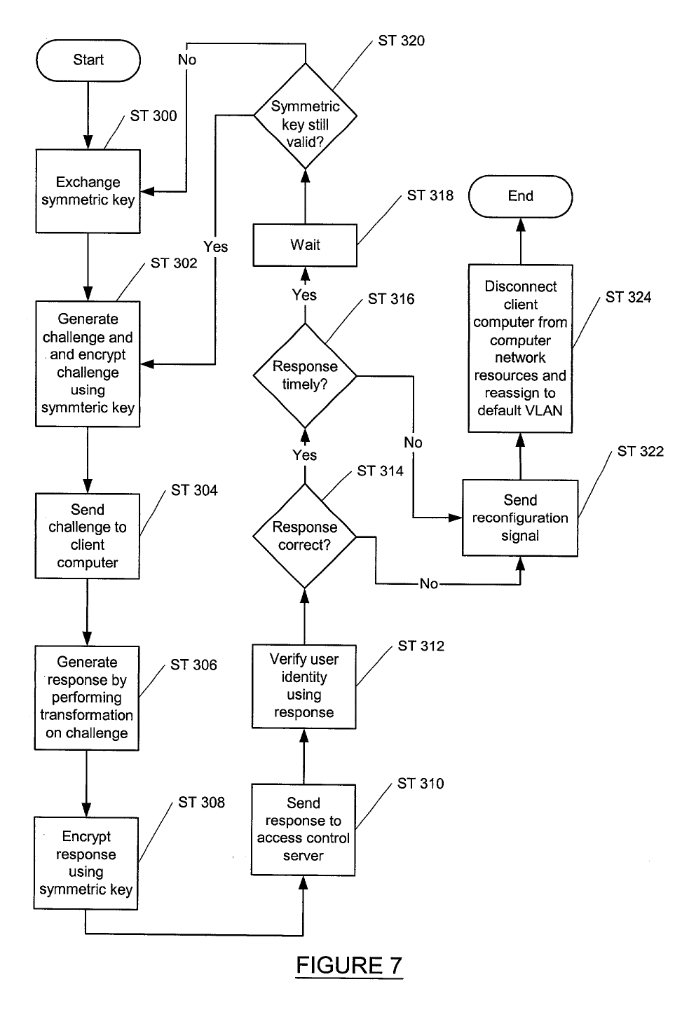

A sequence of operations to accomplish user-friendly mode maintenance access is shown in FIG. 7. A symmetric key is generated on the access control server, or “on the fly” between the client computer and the access control server. After generating the symmetric key, the symmetric key is exchanged between the access control server and the client computer (Step 300). The symmetric key is valid for a single session and is used to verify that the user is still using the client computer. Once the symmetric key has been exchanged, the access control server generates a challenge (e.g., a PKI challenge) and encrypts the challenge using the symmetric key (Step 302) and sends the challenge to the client computer (Step 304). The client computer performs a cryptographic transformation on the challenge to generate a response to the challenge (Step 306). The response is then encrypted by the client computer using the symmetric key (Step 308), and the response which is sent to the access control server (Step 310). After receiving the response, the access control server verifies user identity using the response (Step 312).

Using a result of verifying the response, a determination is made as to whether the response is correct (Step 314). If the response is correct, a determination is made as to whether the response is timely (Step 316). For security purposes, a time window is set for timeliness. If the response is timely, an appropriate waiting period is allowed to elapse (Step 318), and a determination is made as to whether the symmetric key is still valid (Step 320). The symmetric key is no longer valid when a certain configurable time period after generation of the symmetric key elapses. If the symmetric key is still valid, then Step 302 is performed. Otherwise, if the symmetric key is not valid, Step 300 is performed. If the response is determined to not be correct in Step 314, or if the response is determined to not be timely in Step 316, a reconfiguration signal is sent from the connection manager of the access control server to the switch (Step 322). The switch fabric of the switch is manipulated in order to assign the switch port onto which the client computer is connected into the default VLAN and to disconnect the client computer from the corporate network (Step 324).

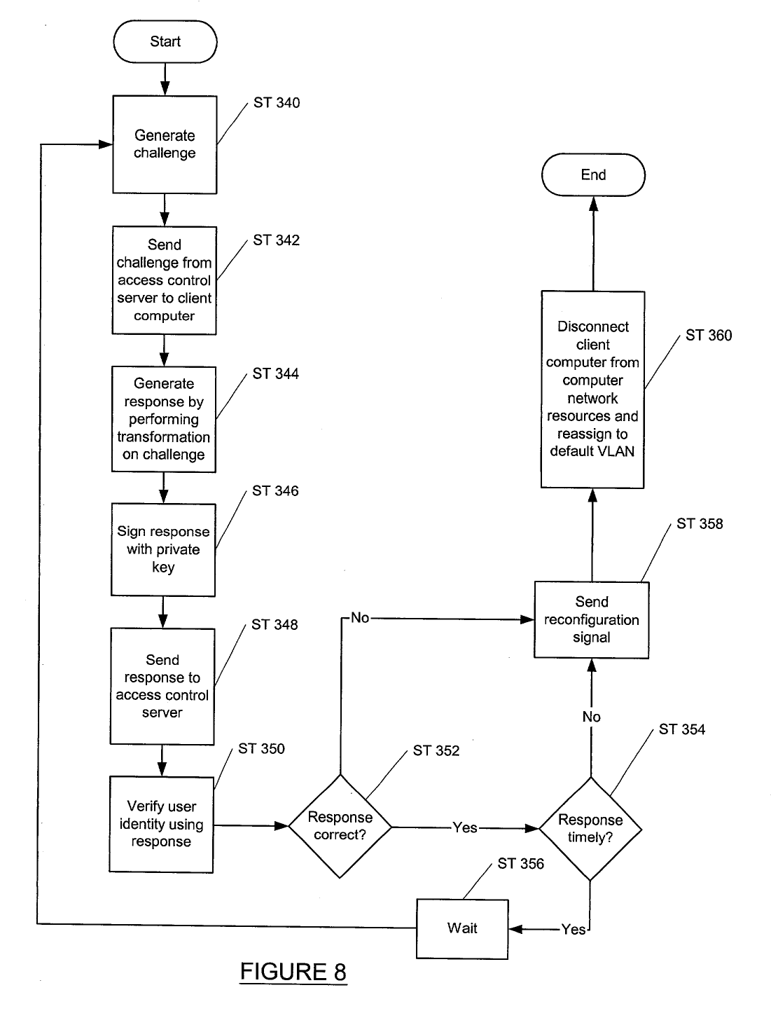

A sequence of operations to accomplish secure mode maintenance access is shown in FIG. 8. A first operation entails generating a challenge by the access control server (Step 340). For example, the challenge may be generated using a pseudo random number generator. After the challenge is generated on the access control server, the challenge is sent to the client computer (Step 342).

The client computer performs a cryptographic transformation on the challenge to generate a response (Step 344) and signs the response using the private key from the security device (Step 346). The response is sent to the access control server (Step 348). Once the response is received by the access control server, the access control server uses the response to verify user identity (Step 350). For example, the access control server may use a public key to verify user identity.

Using a result of verifying user identity, a determination is made as to whether the response is correct (Step 352). If the response is correct, a determination is made as to whether the response is timely (Step 354). For security purposes, a time window is set for timeliness of responses. If the response is timely, an appropriate, configurable waiting period is allowed to elapse (Step 356), and another challenge is generated by performing Step 340. Otherwise, if the response is not valid, or if the response is not timely, a reconfiguration signal is sent from the connection manager of the access control server to the switch (Step 358). The switch fabric of the switch is manipulated in order to assign the switch port onto which the client computer is connected into the default VLAN to disconnect the client computer from the corporate network and reassign the client computer to a default VLAN (Step 360).

Advantages of one or more embodiments of the invention may include one or more of the following. Functionality is provided to grant and deny access to corporate network resources at the switch level based on a result of two-factor PKI identity authentication with non-repudiation. Also, accountability for audit purposes is enhanced.

Those skilled in the art will appreciate that the present invention may have further advantages.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A network system comprising:
a corporate network resource;
a default network isolated from the corporate network resource;
a client computer initially connected to the default network; and
a switch comprising software to dynamically connect the client computer to the corporate network resource if an authentication response obtained from the client computer is valid.

2. The network system of claim 1, the software comprising an access control server.

3. The network system of claim 1, the client computer comprising a cryptographic function.

4. The network system of claim 1, the network system comprising a virtual local area network.

5. The network system of claim 1, wherein the switch is configured to disconnect the client computer from the corporate network resource using a re-configuration signal from the software.

6. The network system of claim 5, the switch further comprising:
a switching fabric manipulated by the re-configuration signal in order to connect the client computer to the corporate network resource.

7. The network system of claim 1, wherein the switch is a local area network switch.

8. The network system of claim 1, wherein the switch provides simple network management protocol support.

9. The network system of claim 1, the switch further comprising a simple network management protocol agent.

10. The network system of claim 1, the software further comprising a simple network management protocol manager.

11. The network system of claim 1, further comprising:
a directory service operatively connected to the software.

12. The network system of claim 11, wherein the directory service is lightweight directory access protocol compliant.

13. The network system of claim 1, further comprising:
a security device read by a security device reader operatively connected to the client computer.

14. The network system of claim 13, wherein the security device holds identity credentials.

15. The network system of claim 13, wherein the security device is a smart card.

16. The network system of claim 1, further comprising:
a log server storing session information.

17. The network system of claim 16, further comprising:
an administrative interface accessing the session information.

18. The network system of claim 17, wherein the administrative interface generates a display using the session information.

19. A network system comprising:
a corporate network resource;
a default network isolated from the corporate network resource;
a client computer initially connected to the default network;
a switch comprising software to connect the client computer to the corporate network resource if an authentication response obtained from the client computer is valid; and
a security device, read by a security device reader, operatively connected to the client computer.

20. A method for connecting a client computer to a corporate network resource, comprising:
obtaining a connection to a default network;
triggering a request for an authentication response from the default network;
generating the authentication response using a security device reader;
sending the authentication response in response to the request;
sending a reconfiguration signal to a switch if the response is correct; and
re-configuring the switch using the re-configuration signal to connect the client computer to the corporate network resource.

21. The method of claim 20, triggering the request comprising a simple network management protocol trap.

22. The method of claim 20, wherein the default network is a virtual local area network.

23. The method of claim 20, generating the authentication response comprising obtaining identity credentials via the security device reader.

24. The method of claim 23, further comprising:
caching the identity credentials on a data store accessible to the client computer.

25. The method of claim 20, generating the authentication response comprising using a private key from a security device.

26. The method of claim 20, further comprising:
verifying user identity using the authentication response and an authentication server.

27. The method of claim 20, further comprising:
storing session information on a log server.

28. The method of claim 27, further comprising:
using the session information to generate a display.

29. The method of claim 27, the session information comprising a media access control address of the client computer.

30. The method of claim 27, the session information comprising a port number of the switch to which the client computer is attached.

31. The method of claim 27, the session information comprising an Internet protocol address of the switch.

32. A method for connecting a client computer to a corporate network resource, comprising:
obtaining a connection to a default network;
triggering a request for an authentication response from the default network;
generating the authentication response using a security device reader;
sending the authentication response in response to the request;
verifying user identity using the authentication response and an authentication server;
sending a reconfiguration signal to a switch if the authentication response is valid; and
re-configuring the switch using the re-configuration signal to connect the client computer to the corporate network resource.

33. A method for maintaining a connection to a corporate network resource, comprising:
sending a challenge to a client computer connected to the corporate network resource;
returning a response to the challenge;
verifying whether the response to the challenge is correct;
re-configuring a switch to terminate the connection to the corporate network resource, if the response to the challenge is not correct; and
maintaining the connection to the connection to the corporate network resource, if the response to the challenge is correct;
wherein a security device reader is used to generate an authentication response to initially connect the client computer to the corporate network resource.

34. The method of claim 33, wherein the challenge is generated using a symmetric key.

35. The method of claim 33, wherein the challenge is generated periodically.

36. The method of claim 33, re-configuring the switch comprising:
sending a reconfiguration signal to the switch if the response to the challenge is not correct.

37. The method of claim 33, further comprising:
placing the client computer in a default network if the response to the challenge is not correct.
sending a challenge to a client computer connected to the corporate network resource;
returning a response to the challenge;
verifying whether the response to the challenge is correct;
re-configuring a switch to terminate the connection to the corporate network resource, if the response to the challenge is not correct;
placing the client computer in a default network if the response to the challenge is not correct; and
maintaining the connection to the connection to the corporate network resource, if the response to the challenge is correct;
wherein a security device reader is used to generate an authentication response to initially connect the client computer to the corporate network resource.

38. A computer system for connecting a client computer to a corporate network resource, comprising:
a processor;
a memory;
a storage device; and
software instructions stored in the memory for enabling the computer system to perform:
obtaining a connection to a default network;
triggering a request for an authentication response from the default network;
generating the authentication response using a security device reader;
sending the authentication response in response to the request;
sending a reconfiguration signal to a switch if the response is correct; and
re-configuring the switch using the re-configuration signal to connect the client computer to the corporate network resource.

39. A computer system for maintaining a connection to a corporate network resource, comprising:
a processor;
a memory;
a storage device; and
software instructions stored in the memory for enabling the computer system to perform:
sending a challenge to a client computer connected to the corporate network resource;
returning a response to the challenge;
verifying whether the response to the challenge is correct;
re-configuring a switch to terminate the connection to the corporate network resource, if the response to the challenge is not correct; and
maintaining the connection to the connection to the corporate network resource, if the response to the challenge is correct;
wherein a security device reader is used to generate an authentication response to initially connect the client computer to the corporate network resource.

40. An apparatus for connecting a client computer to a corporate network resource, comprising:
means for obtaining a connection to a default network;
means for triggering a request for an authentication response from the default network;
means for generating the authentication response using a security device reader;
means for sending the authentication response in response to the request;
means for sending a reconfiguration signal to a switch if the response is correct; and
means for re-configuring the switch using the re-configuration signal to connect the client computer to the corporate network resource.

41. An apparatus for maintaining a connection to a corporate network resource, comprising:
means for sending a challenge to a client computer connected to the corporate network resource;
means for returning a response to the challenge;
means for verifying whether the response to the challenge is correct;
means for re-configuring a switch to terminate the connection to the corporate network resource, if the response to the challenge is not correct; and
means for maintaining the connection to the connection to the corporate network resource, if the response to the challenge is correct;
wherein a security device reader is used to generate an authentication response to initially connect the client computer to the corporate network resource.
